(19) United States
(12) Patent Application Publication
(10) Pub. No.: US 2026/0012956 A1
(43) Pub. Date: Jan. 8, 2026

(54) PHYSICAL SIDELINK FEEDBACK CHANNEL MULTIPLEXING WITH PHYSICAL SIDELINK SHARED CHANNEL

(71) Applicant: QUALCOMM Incorporated, San Diego, CA (US)

(72) Inventors: Siyi CHEN, Beijing (CN); Jing SUN, San Diego, CA (US); Chih-Hao LIU, San Diego, CA (US); Xiaoxia ZHANG, San Diego, CA (US); Changlong XU, Beijing (CN); Shaozhen GUO, Beijing (CN); Luanxia YANG, Beijing (CN); Hao XU, Beijing (CN)

(21) Appl. No.: 18/881,528

(22) PCT Filed: Aug. 15, 2022
(86) PCT No.: PCT/CN2022/112367

§ 371 Date: Jan. 6, 2025

(51) Int. Cl. H04W 72/25; H04L 1/1812

(52) U.S. Cl. CPC H04W 72/25; H04L 1/1812

(57) ABSTRACT

Various aspects of the present disclosure generally relate to wireless communication. In some aspects, a user equipment (UE) may receive a first physical sidelink shared channel (PSSCH) message. The UE may transmit a second PSSCH message, wherein the second PSSCH message is multiplexed with a physical sidelink feedback channel (PSFCH) that carries hybrid automatic repeat request (HARQ) feedback for the first PSSCH message. Numerous other aspects are described.

### FIELD OF THE DISCLOSURE

Aspects of the present disclosure generally relate to wireless communication and to techniques and apparatuses for physical sidelink feedback channel (PSFCH) multiplexing with a physical sidelink shared channel (PSSCH).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a first physical sidelink shared channel (PSSCH) message. The method may include transmitting a second PSSCH message, wherein the second PSSCH message is multiplexed with a physical sidelink feedback channel (PSFCH) that carries hybrid automatic repeat request (HARQ) feedback for the first PSSCH message.

Some aspects described herein relate to a UE for wireless communication. The UE may include a memory and one or more processors coupled to the memory. The one or more processors may be configured to receive a first PSSCH message. The one or more processors may be configured to transmit a second PSSCH message, wherein the second PSSCH message is multiplexed with a PSFCH that carries HARQ feedback for the first PSSCH message.

Some aspects described herein relate to a non-transitory computer-readable medium that stores a set of instructions for wireless communication by a UE. The set of instructions, when executed by one or more processors of the UE, may cause the UE to receive a first PSSCH message. The set of instructions, when executed by one or more processors of the UE, may cause the UE to transmit a second PSSCH message, wherein the second PSSCH message is multiplexed with a PSFCH that carries HARQ feedback for the first PSSCH message.

Some aspects described herein relate to an apparatus for wireless communication. The apparatus may include means for receiving a first PSSCH message. The apparatus may include means for transmitting a second PSSCH message, wherein the second PSSCH message is multiplexed with a PSFCH that carries HARQ feedback for the first PSSCH message.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram illustrating an example of resources associated with a physical sidelink feedback channel (PSFCH), in accordance with the present disclosure.

FIGS. 6A-6F are diagrams illustrating examples associated with PSFCH multiplexing with a physical sidelink shared channel (PSSCH), in accordance with the present disclosure.

FIG. 7 is a diagram illustrating an example process associated with PSFCH multiplexing with a PSSCH, in accordance with the present disclosure.

FIG. 8 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

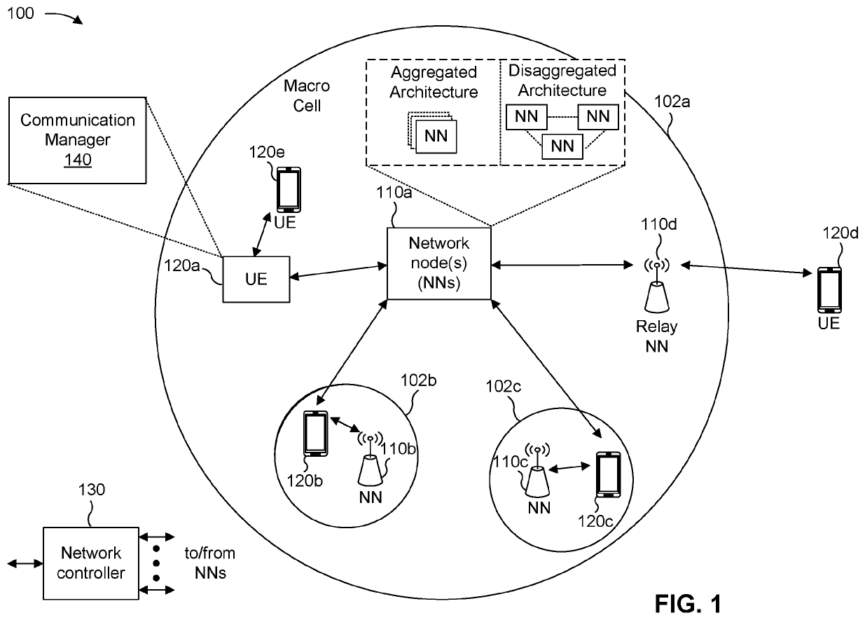

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a first physical sidelink shared channel (PSSCH) message; and transmit a second PSSCH message, wherein the second PSSCH message is multiplexed with a physical sidelink feedback channel (PSFCH) that carries hybrid automatic repeat request (HARQ) feedback for the first PSSCH message. Additionally, or alternatively, the communication manager 140 may perform one or more other operations described herein.

As indicated above, FIG. 1 is provided as an example. Other examples may differ from what is described with regard to FIG. 1.

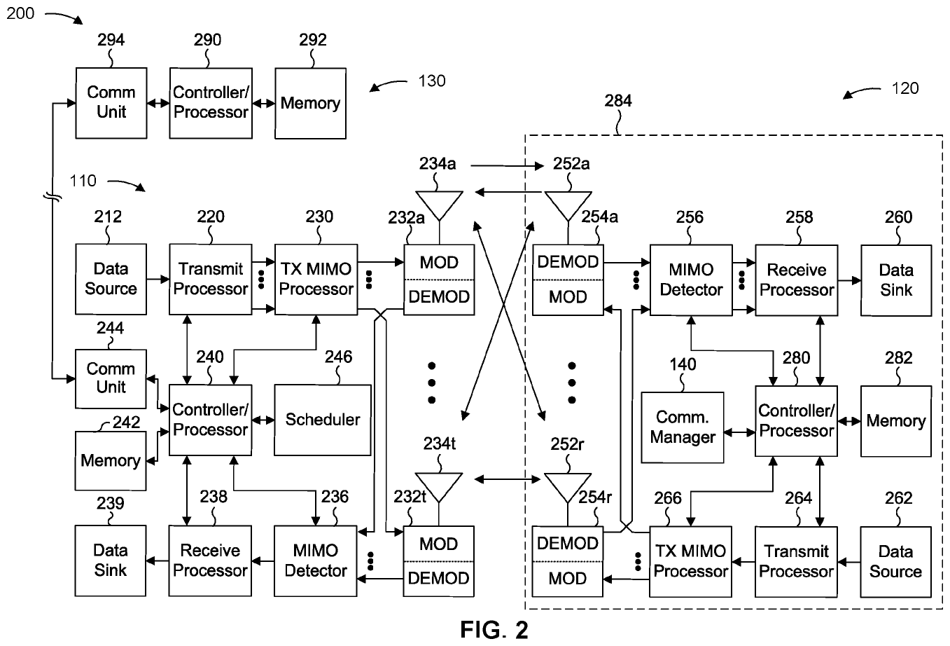

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

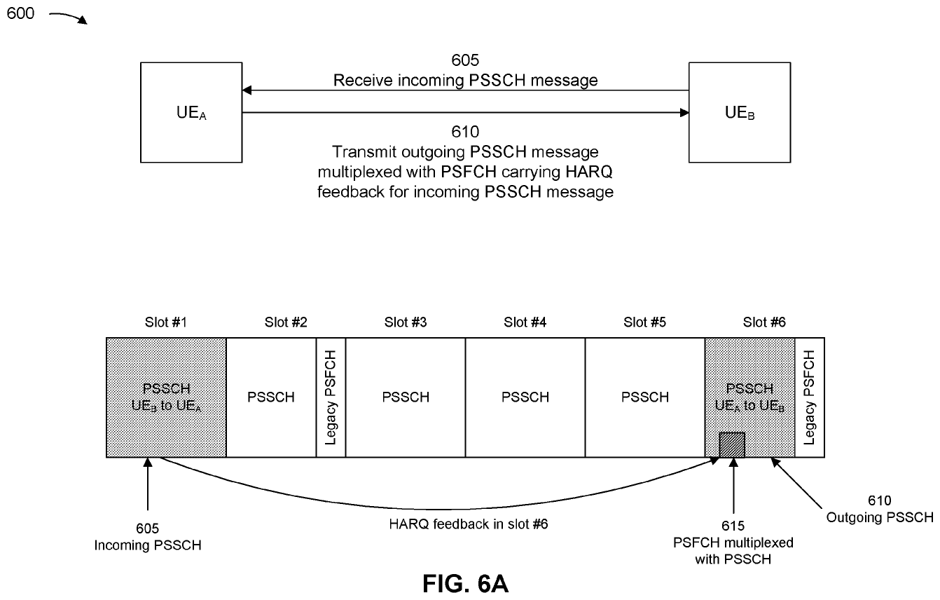

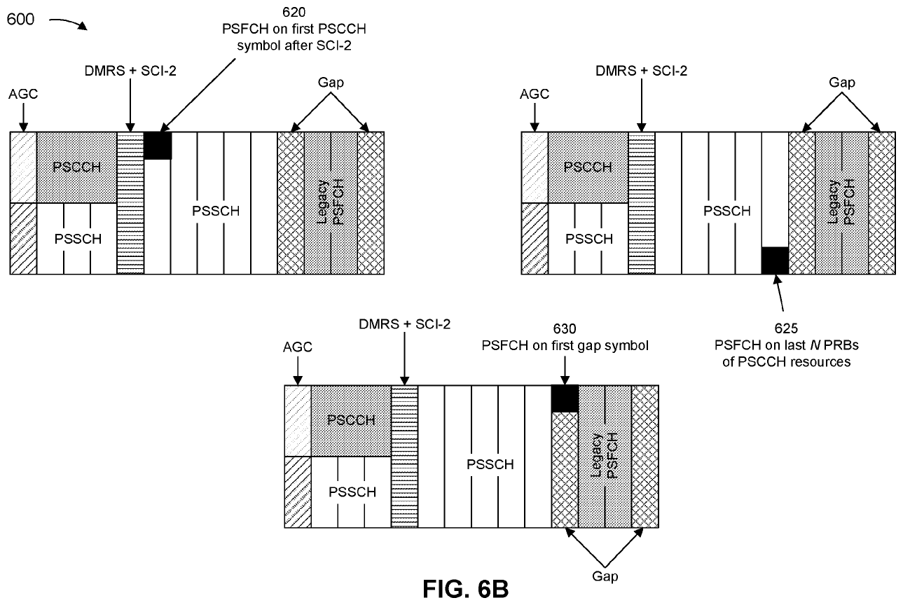

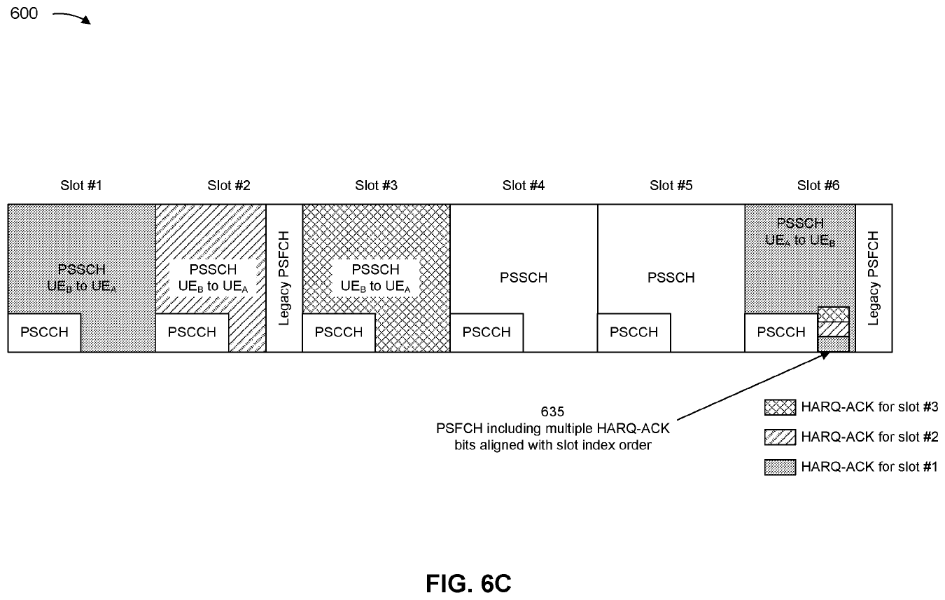

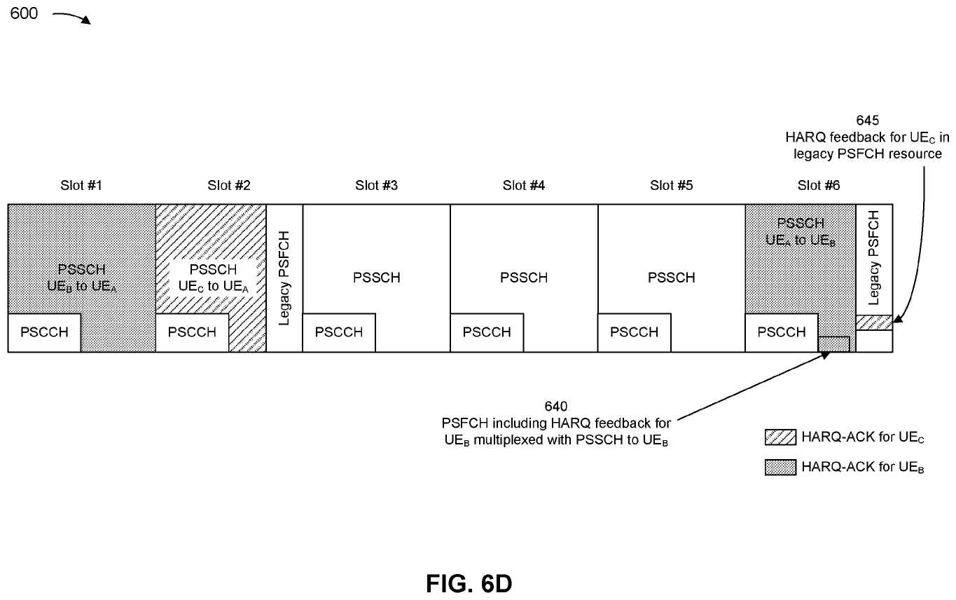

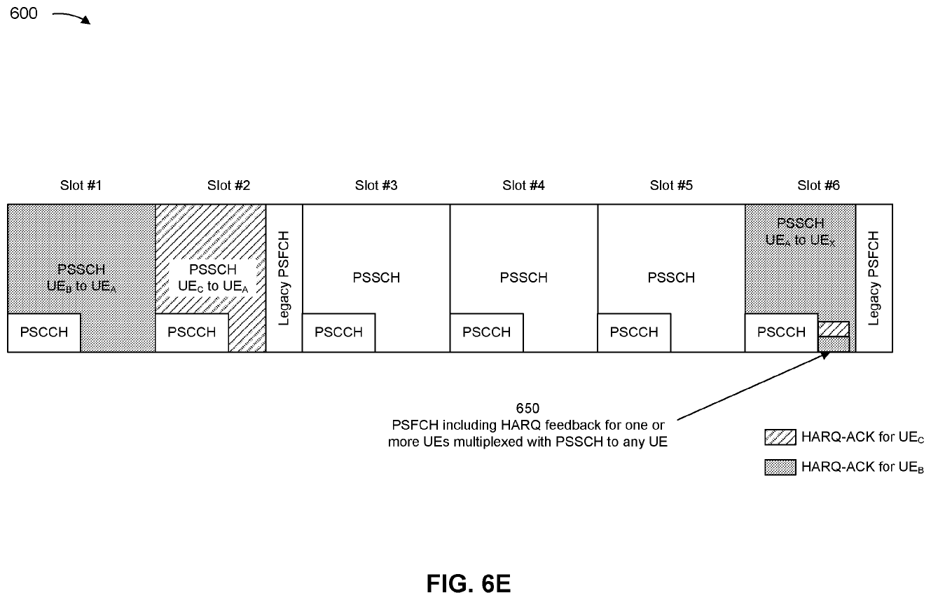

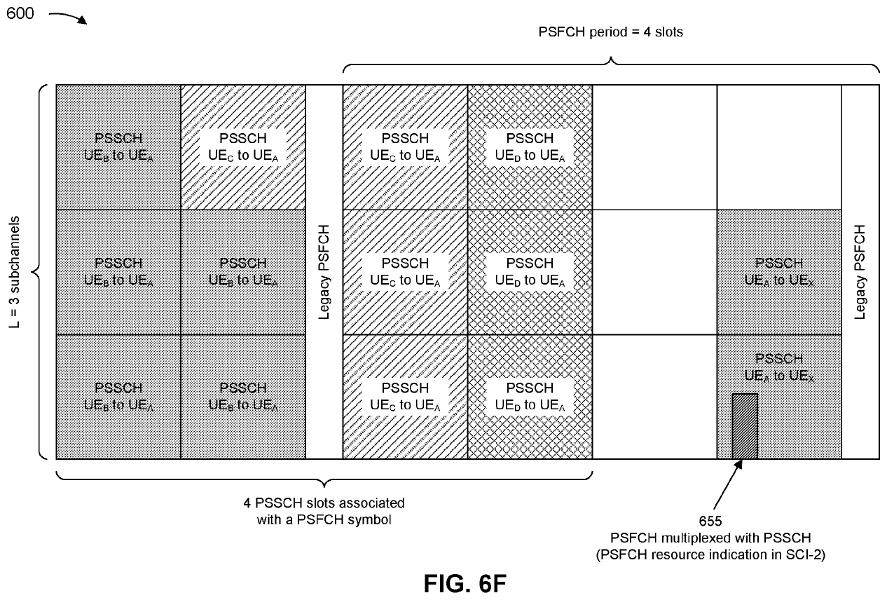

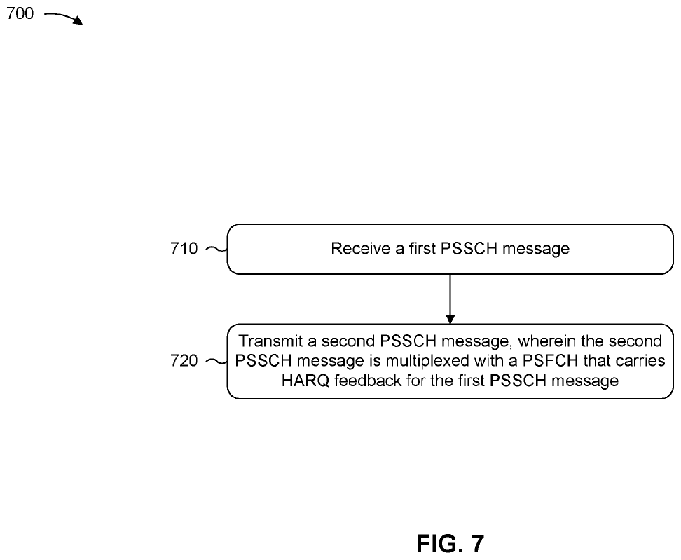

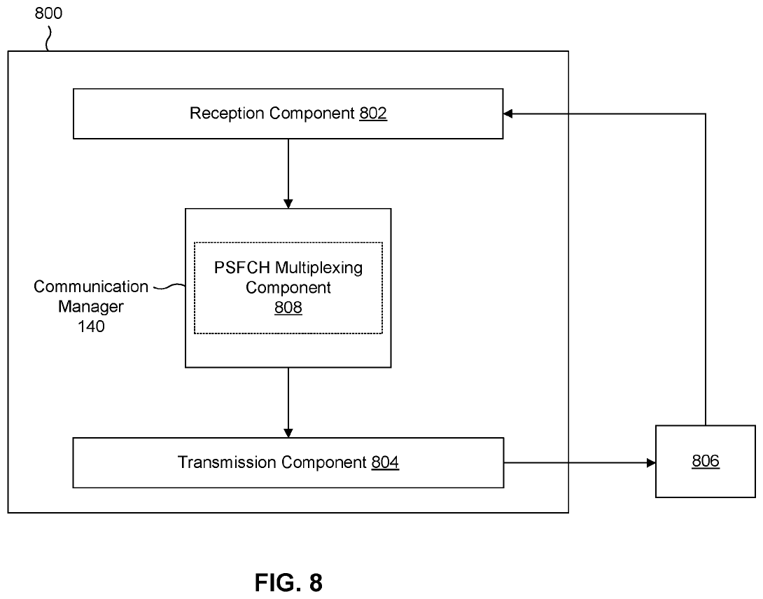

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6A-6F and/or FIGS. 7-8).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6A-6F and/or FIGS. 7-8).

The controller/processor 240 of the network node 110, the controller/processor 280 of the UE 120, and/or any other component(s) of FIG. 2 may perform one or more techniques associated with PSFCH multiplexing with a PSSCH, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7 and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7 and/or other processes as described herein. In some examples, executing instructions may include running the instructions, converting the instructions, compiling the instructions, and/or interpreting the instructions, among other examples.

In some aspects, the UE 120 includes means for receiving a first PSSCH message; and/or means for transmitting a second PSSCH message, wherein the second PSSCH message is multiplexed with a PSFCH that carries HARQ feedback for the first PSSCH message. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

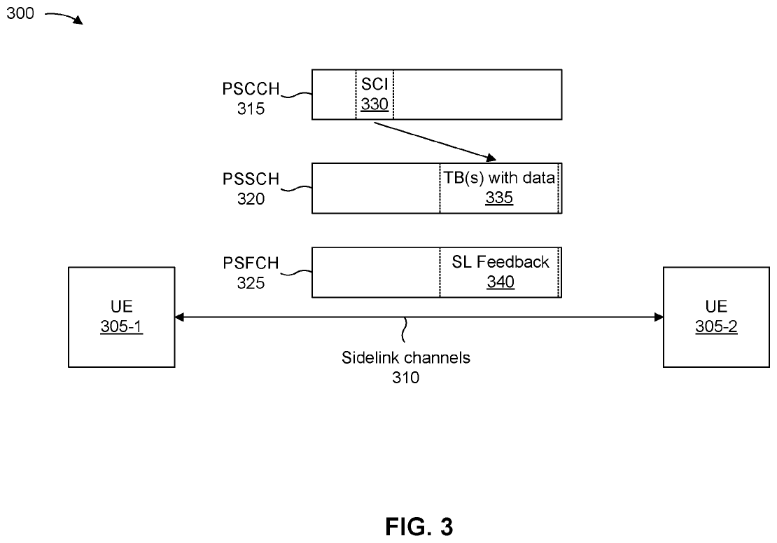

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a PSSCH 320, and/or a PSFCH 325. The PSCCH 315 may be used to communicate control information, similar to a physical downlink control channel (PDCCH) and/or a physical uplink control channel (PUCCH) used for cellular communications with a network node 110 via an access link or an access channel. The PSSCH 320 may be used to communicate data, similar to a physical downlink shared channel (PDSCH) and/or a physical uplink shared channel (PUSCH) used for cellular communications with a network node 110 via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as HARQ feedback (e.g., acknowledgement or negative acknowledgement (ACK/NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QoS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 320, such as a HARQ process ID, a new data indicator (NDI), a source identifier, a destination identifier, and/or a channel state information (CSI) report trigger.

In some aspects, the one or more sidelink channels 310 may use resource pools. For example, a scheduling assignment (e.g., included in SCI 330) may be transmitted in subchannels using specific physical resource blocks (PRBs) across time. In some aspects, data transmissions (e.g., on the PSSCH 320) associated with a scheduling assignment may occupy adjacent PRBs in the same subframe as the scheduling assignment (e.g., using frequency division multiplexing). In some aspects, a scheduling assignment and associated data transmissions are not transmitted on adjacent PRBs.

In some aspects, a UE 305 may operate using a sidelink transmission mode (e.g., Mode 1) where resource selection and/or scheduling is performed by a network node 110 (e.g., a base station, a CU, or a DU). For example, the UE 305 may receive a grant (e.g., in downlink control information (DCI) or in a radio resource control (RRC) message, such as for configured grants) from the network node 110 (e.g., directly or via one or more network nodes) for sidelink channel access and/or scheduling. In some aspects, a UE 305 may operate using a transmission mode (e.g., Mode 2) where resource selection and/or scheduling is performed by the UE 305 (e.g., rather than a network node 110). In some aspects, the UE 305 may perform resource selection and/or scheduling by sensing channel availability for transmissions. For example, the UE 305 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy ratio (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or an MCS to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

As indicated above, FIG. 3 is provided as an example. Other examples may differ from what is described with respect to FIG. 3.

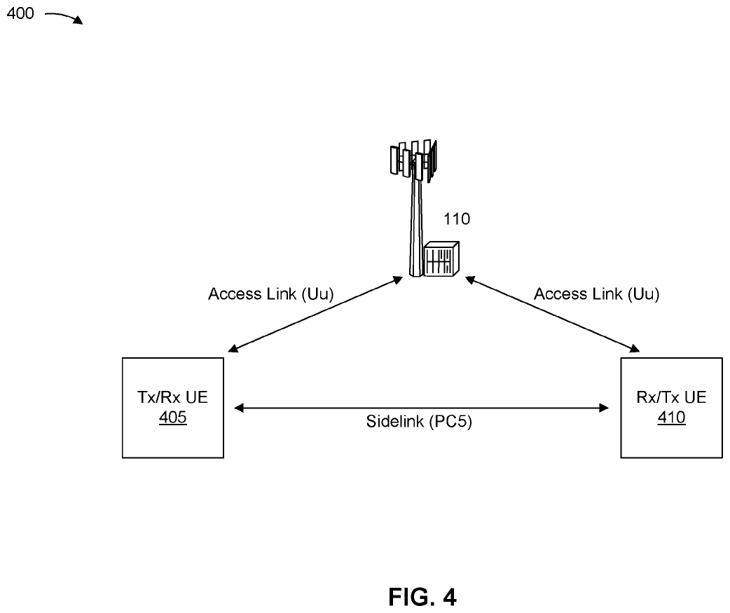

FIG. 4 is a diagram illustrating an example 400 of sidelink communications and access link communications, in accordance with the present disclosure.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a network node 110 may communicate with the Tx/Rx UE 405 (e.g., directly or via one or more network nodes), such as via a first access link. Additionally, or alternatively, in some sidelink modes, the network node 110 may communicate with the Rx/Tx UE 410 (e.g., directly or via one or more network nodes), such as via a first access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a network node 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

As indicated above, FIG. 4 is provided as an example. Other examples may differ from what is described with respect to FIG. 4.

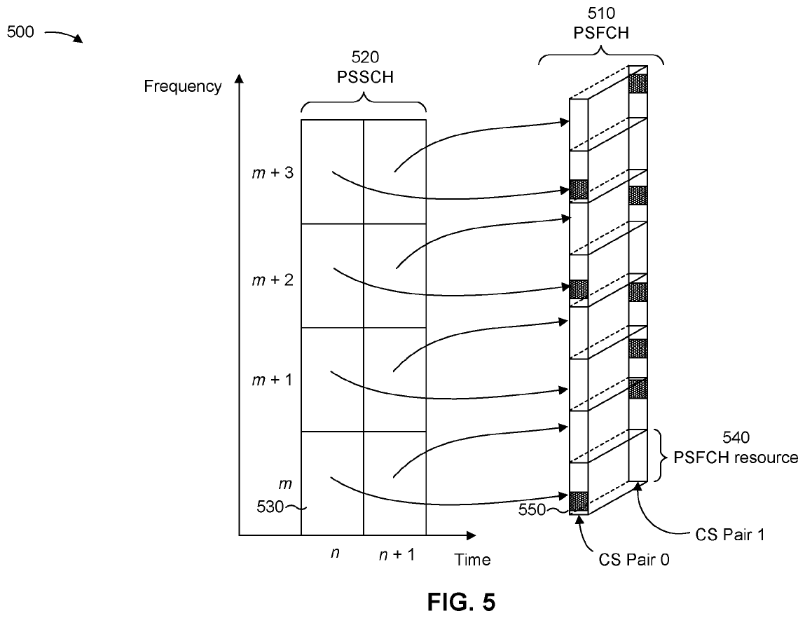

FIG. 5 is a diagram illustrating an example 500 of resources associated with a PSFCH 510, in accordance with the present disclosure. As described herein, the resources shown in example 500 may be associated with sidelink communications, such as the sidelink communications described in connection with FIG. 3 and FIG. 4. For example, the resources shown in example 500 and described herein may be associated with sidelink communications between and/or among multiple UEs (e.g., UE 120, UE 305-1, UE 305-2, Tx/Rx UE 405, and/or Rx/Tx UE 410, among other examples). Additionally, or alternatively, the PSFCH 510 shown in FIG. 5 and described herein may correspond to the PSFCH 325 described in connection with FIG. 3.

In some aspects, the PSFCH 510 may be associated with (e.g., be used to carry or otherwise provide HARQ feedback related to) a PSSCH 520, which may correspond to the PSSCH 320 described in connection with FIG. 3. For example, in some aspects, the HARQ feedback may include an ACK to indicate that a responding UE successfully received and decoded a PSSCH message transmitted on the PSSCH 520 or a NACK to indicate that the responding UE failed to receive or failed to decode a PSSCH message transmitted on the PSSCH 520. In some aspects, the PSSCH 520 may be associated with a set of PSSCH occasion 530, which may be present across a resource grid associated with slots n and n+1 and subchannels m, m+1, m+2, and m+3. Each PSSCH occasion 530 may correspond to a different PSFCH resource 540 associated with the PSFCH 510. For example, for a PSSCH communication received in slot n and subchannel m, a responding UE may transmit HARQ feedback information 550 over multiple PRBs within a corresponding PSFCH resource 540, as shown by the arrow connecting the PSSCH occasion 530 associated with slot n and subchannel m with the PSFCH resource 540 including the HARQ feedback information 550. Similarly, the other PSSCH occasions 530 may each be associated with a corresponding PSFCH resource 540. In some cases, for each PSFCH resource 540, a responding UE may use multiple length-12 sequence repetitions across multiple PRBs and/or may use different cyclic shift (CS) pairs (e.g., CS pair 0 and CS pair 1) to differentiate between an ACK or a NACK for each sequence.

In some instances, resources associated with the PSFCH 510 may be associated with a resource pool, which is not a dedicated PSFCH resource pool in example 500. Instead, in example 500, the resource pool associated with the PSFCH 510 includes resources for multiple sidelink communication types (e.g., different sidelink channels), such as PSSCH communications and/or PSCCH communications in addition to PSFCH communications. In such cases, the responding UE providing the HARQ feedback information 550 may be configured with one or more parameters to determine the PSFCH 510 and/or a specific PSFCH resource 540 to use to transmit the HARQ feedback information 550. For example, the responding UE may receive an indication of a PSFCH period parameter (e.g., a periodPSFCHresource parameter), which may indicate a period (in a number of slots) within a resource pool for a PSFCH transmission. In some cases, the PSFCH period parameter may have a value equal to zero (0), which may indicate that there is no PSFCH, or the PSFCH period parameter may have a value of one slot, two slots, or four slots. For a given PSSCH 520, the responding UE may then transmit the HARQ feedback information 550 (e.g., ACK/NACK information) in a first slot associated with a PSFCH resource 540 after the PSSCH 520 and following a minimum time gap, which may be indicated by a PSFCH minimum time gap parameter (e.g., a minTimeGapPSFCH parameter).

Additionally, or alternatively, a responding UE may receive an indication of a set of PRBs within a slot that are used for PSFCH transmission and reception (e.g., denoted

$${M}_{PRB , set}^{PSFCH}$$

and/or indicated in an sl-PSFCH-RB-Set parameter). Accordingly, each PSSCH occasion 530 may be associated with a number of PRBs, which may be a subset of

$${M}_{PRB , set}^{PSFCH} .$$

More particularly, a PSSCH 520 may be associated with a number of slots associated with one PSFCH 510 slot (e.g., denoted

$${N}_{PSSCH}^{PSFCH} ,$$

which, in example 500, is equal to two (2) corresponding to slot n and slot n+1), and/or a PSSCH 520 may be associated with a number of subchannels within each slot (e.g., denoted

$${N}_{subch}^{PSSCH} ,$$

which, in example 500, is equal to four (4) corresponding to subchannels m, m+1, m+2, and m+3). In such cases, each subchannel and/or slot of the PSSCH 520 resource grid (e.g., each PSSCH occasion 530) may be associated with a number of PSFCH PRBs (e.g., denoted

$${M}_{subch , slot}^{PSFCH} )$$

for PSFCH transmission and reception, which may be equal to

$$\frac{{M}_{PRB , set}^{PSFCH}}{{N}_{PSSCH}^{PSFCH} \times {N}_{subch}}$$

PRBs. Moreover, a mapping between each subchannel and/or slot of the PSSCH 520 resource grid (e.g., each PSSCH occasion 530) and a corresponding PSFCH resource 540 may be performed in a time-first manner, as shown using arrows in FIG. 5. More particularly, a first-in-time PSSCH occasion 530 (e.g., a PSSCH occasion 530 in slot n) in a first subchannel (e.g., subchannel m) may be mapped to a first PSFCH resource 540, a second-in-time PSSCH occasion 530 in a first subchannel may be mapped to a second PSFCH resource 540, a first-in-time PSSCH occasion 530 in a second subchannel may be mapped to a third PSFCH resource 540, and so forth.

In some cases, a size of a PSFCH resource pool (e.g., denoted

$${R}_{PRB , CS}^{PSFCH} ) ,$$

may be equal to

$${N}_{type}^{PSFCH} \times {N}_{CS}^{PSFCH} \times {M}_{subch , slot}^{PSFCH} .$$

In such cases,

$${N}_{type}^{PSFCH}$$

may be based at least in part on whether the PSFCH resource pool is associated with multiple subchannels in a PSSCH slot. For example,

$${N}_{type}^{PSFCH}$$

may be equal to one (1) if the PSFCH resource pool is only associated with one PSSCH subchannel, or may otherwise equal the number of subchannels within each PSSCH slot (e.g.,

$${N}_{subch}^{PSSCH} ) .$$

Furthermore, the term

$${N}_{CS}^{PSFCH}$$

may correspond to a number of cyclic shift pairs associated with the PSFCH resource pool, which may be configured per resource pool, and the term

$${M}_{s u b ch , slot}^{P S F C H}$$

may correspond to the number of PSFCH PRBs associated with each subchannel and/or slot of the PSSCH 520 resource grid (e.g., each PSSCH occasion 530), as described above. Additionally, or alternatively, a responding UE may determine a PSFCH resource according to the formula

$$( {P}_{ID} + {M}_{ID} ) mod {R}_{PRB , CS}^{PSFCH} ,$$

where

$${R}_{PRB , CS}^{PSFCH}$$

corresponds to the size of the PSFCH resource pool (as described above), P_{ID} corresponds to a physical source identifier indicated by an SCI message (e.g., SCI-2A or SCI-2B) associated with the PSSCH 520, and M_{ID} is either zero (0) or corresponds to an identity of the responding UE receiving the PSSCH 520. In other words, for a unicast transmission, M_{ID} may be equal to zero (0) and the responding UE will provide feedback in a PSFCH resource pool that depends only on a source identifier (e.g., P_{ID}), and for a groupcast transmission, each receiving UE may pick a separate resource in the resource pool for transmitting feedback, which is dependent on both P_{ID} and M_{ID}.

When a UE is communicating with a network node over an access link or Uu interface (e.g., as shown in FIG. 4), one or more PDSCH messages may be scheduled for transmission from the network node to the UE (e.g., based on a dynamic grant or an SPS configuration). In such cases, the UE may generate HARQ feedback that includes an ACK to indicate that the UE received and successfully decoded a scheduled PDSCH message or a NACK to indicate that the scheduled PDSCH message was not received (e.g., did not arrive at the UE) or that the UE was unable to successfully decode the scheduled PDSCH message. Accordingly, the UE may transmit a PUCCH message that carries the HARQ feedback to the network node to either inform the network node that the scheduled PDSCH message was correctly received and decoded or request that the network node retransmit the PDSCH message. In some cases, the UE can multiplex the PUCCH with a PUSCH message that carries an uplink transport block (e.g., sometimes referred to as “piggybacking” the PUCCH onto the PUSCH message), where the PUCCH is transmitted in one or more PRBs that are otherwise allocated to the PUSCH message. In such cases, multiplexing the PUCCH with (or piggybacking the PUCCH onto) the PUSCH message can significantly improve transmission efficiency associated with the HARQ feedback (e.g., because separate time and/or frequency resources do not need to be allocated to the PUCCH).

In general, applying similar multiplexing or piggybacking techniques to sidelink communications may improve efficiency when a responding UE that is providing HARQ feedback to a transmitting UE also has sidelink data to transmit in a PSSCH message. For example, when the transmitting UE and the responding UE are engaged in sidelink communication over unlicensed spectrum, the responding UE can multiplex the HARQ feedback with a PSSCH message that carries sidelink data within the same channel occupancy time. In this case, the responding UE may avoid a need to perform a separate listen-before-talk (LBT) procedure for a transmission of the PSSCH message and a transmission of a PSFCH that carries the HARQ feedback. As a result, an LBT failure probability may be reduced, which may improve latency and reliability for sidelink communications over unlicensed spectrum. Furthermore, combining the HARQ feedback and the PSSCH message into a single transmission may generally improve efficiency by avoiding a need to allocate PSFCH resources from a PSFCH resource pool. Accordingly, some aspects described herein relate to various techniques to multiplex a PSFCH with (or piggyback a PSFCH onto) a PSSCH.

As indicated above, FIG. 5 is provided as an example. Other examples may differ from what is described with respect to FIG. 5.

FIGS. 6A-6F are diagrams illustrating examples 600 associated with PSFCH multiplexing with a PSSCH, in accordance with the present disclosure. As described herein, examples 600 include communication between a responding UE (shown in FIGS. 6A-6F as UE_{A}) and one or more Tx/Rx UEs (shown in FIGS. 6A-6F as UE_{B}, UE_{C}, UE_{D}, UE_{X}, or the like). In some aspects, the responding UE and the Tx/Rx UE(s) may communicate in a wireless network, such as wireless network 100. The responding UE and the Tx/Rx UE(s) may communicate via a wireless sidelink, which may include a PC5 interface, in unlicensed or licensed spectrum. In general, the responding UE and the Tx/Rx UE(s) may correspond to one or more UEs described herein, such as UE 120, UE 305-1, UE 305-2, Tx/Rx UE 405, and/or Rx/Tx UE 410, among other examples.

In some aspects, examples 600 generally relate to techniques that the responding UE may use to multiplex a PSFCH with a PSSCH when the responding UE receives one or more incoming PSSCH messages from one or more Tx/Rx UEs that are associated with requests for HARQ feedback, and the responding UE also has sidelink data to transmit. In such cases, as described herein in connection with FIGS. 6A-6F, the responding UE may be configured to multiplex a PSFCH that carries the HARQ feedback for the one or more incoming PSCCH messages with an outgoing PSSCH message. For example, as described herein, the responding UE may multiplex the PSFCH with (or piggyback the PSFCH onto) the outgoing PSSCH message by transmitting the PSFCH using one or more time and frequency resources (e.g., PRBs) that are included in or adjacent to time and frequency resources allocated to the outgoing PSSCH message. Additionally, or alternatively, in cases where the PSFCH cannot be suitably multiplexed with or piggybacked onto the outgoing PSSCH message, the responding UE may transmit the PSFCH carrying the HARQ feedback for one or more UEs using a legacy PSFCH resource (e.g., using a PSFCH resource selected from a PSFCH resource pool using techniques described above in connection with FIG. 5).

For example, referring to FIG. 6A, the responding UE may multiplex a PSFCH onto an outgoing PSSCH message in cases where the PSFCH and the outgoing PSSCH are transmitted to the same UE. For example, as shown by reference number 605, the responding UE (shown as UE_{A} in FIG. 6A) may receive an incoming PSSCH message from a Tx/Rx UE (shown as UE_{B} in FIG. 6A). In some aspects, the responding UE may then generate HARQ feedback for the incoming PSSCH message, where the HARQ feedback may include an ACK to indicate that the responding UE received and successfully decoded the incoming PSSCH message or a NACK to indicate that the responding UE failed to receive and/or failed to decode the incoming PSSCH message. For example, in some aspects, the responding UE may generate the HARQ feedback for the incoming PSSCH message based on the incoming PSSCH message including a request (e.g., in SCI) that ACK/NACK feedback be transmitted in a PSFCH. In some aspects, the responding UE may be configured to transmit the HARQ feedback for the incoming PSSCH message according to a fixed timeline (e.g., based on a parameter configuring a minimum gap between a PSSCH message and a PSFCH carrying HARQ feedback for the PSSCH message). For example, in FIG. 6A, the responding UE may receive the incoming PSSCH message in slot #1, and may be configured to transmit the HARQ feedback in slot #6 based on the minimum gap parameter (e.g., the minimum gap parameter may equal two (2) or three (3), whereby the responding UE needs to provide the HARQ feedback in the second slot that has PSFCH resources (slot #6) because the gap between the PSSCH in slot #1 and the first slot that has PSFCH resources (slot #2) does not satisfy the minimum gap parameter).

As shown by reference number 610, in cases where the responding UE is transmitting HARQ feedback to the Tx/Rx UE and also has sidelink data to transmit to the Tx/Rx UE, the responding UE may transmit an outgoing PSSCH message to the Tx/Rx UE, where the outgoing PSSCH message includes sidelink data multiplexed with a PSFCH carrying the HARQ feedback for the incoming PSSCH message. For example, as shown by reference number 615, the PSFCH multiplexed with the outgoing PSSCH message may be transmitted using one or more time and frequency resources (e.g., PRBs) that are included in and/or adjacent to time and frequency resources used to transmit the sidelink data. In general, the multiplexing techniques shown in FIG. 6A (e.g., where the sidelink data and HARQ feedback are multiplexed within a single PSSCH transmission) may be used when the Tx/Rx UE intended to receive the PSFCH and the Tx/Rx UE intended to receive the PSSCH are the same UE (e.g., a source identifier of the incoming PSSCH message for which HARQ feedback is requested matches a destination identifier of the outgoing PSSCH message). In such cases, the Tx/Rx UE that transmitted the initial PSSCH message may monitor the SCI-2 in the slot where the HARQ feedback is expected to be transmitted (e.g., slot #6 in the illustrated example), and the Tx/Rx UE may check the destination identifier included in the SCI-2 associated with the outgoing PSSCH message. Accordingly, in cases where the Tx/Rx UE determines that the SCI-2 in the slot where the HARQ feedback is expected to be transmitted indicates that a destination identifier of the outgoing PSSCH message is assigned to the Tx/Rx UE (e.g., the Tx/Rx UE is the receiver of the PSFCH and the outgoing PSSCH), the Tx/Rx UE may receive the multiplexed/piggybacked PSFCH in a configured location associated with the outgoing PSSCH. Otherwise, in cases where the destination identifier of the outgoing PSSCH message differs from an identifier assigned to the Tx/Rx UE (e.g., the Tx/Rx UE is not the intended receiver of the outgoing PSSCH), the Tx/Rx UE may receive the HARQ feedback for the initial PSSCH message in a legacy PSFCH location (e.g., in a PSFCH resource selected from a PSFCH resource pool using the techniques described in connection with FIG. 5).

Accordingly, when a PSFCH transmitted from a responding UE to a Tx/Rx UE is multiplexed with or piggybacked onto a PSSCH message transmitted from the responding UE to the Tx/Rx UE (e.g., to provide HARQ feedback for an earlier PSSCH message transmitted from the Tx/Rx UE to the responding UE), a source identifier for the earlier PSSCH message may match a destination identifier for the PSSCH message transmitted from the responding UE to the Tx/Rx UE, and a destination identifier for the earlier PSSCH message may match a source identifier for the PSSCH message transmitted from the responding UE to the Tx/Rx UE. In such cases, the PSFCH may be multiplexed with the PSSCH message in a configured location within a sidelink slot that includes PSFCH resources to accommodate a PSFCH. For example, as shown in FIG. 6B, a sidelink slot may generally include fourteen (14) symbols, where a first symbol is used for automatic gain control (AGC) and a PSCCH that conveys SCI to be decoded by any UE for channel sensing purposes (e.g., SCI-1) occupies a number of consecutive PRBs in a starting subchannel of a PSSCH transmission over two or three symbols at the beginning of the slot (e.g., three symbols in the illustrated examples).

As further shown, the symbols occupied by the PSCCH may be followed by a symbol for transmitting a DMRS used for channel estimation purposes and SCI-2 that includes information such as a HARQ process ID, an NDI, a source identifier, a destination identifier, and/or a CSI report trigger. The symbol carrying the DMRS and the SCI-2 may be followed by several PSSCH symbols, which are followed by a first gap (or guard) symbol, two symbols for carrying a legacy PSFCH, and a second gap (or guard) symbol. In general, the two PSFCH symbols may be provided between the gap symbols at the end of the slot in every one, two, or four slots.

Accordingly, when the responding UE multiplexes the PSFCH with the PSSCH in a sidelink slot that includes the two PSFCH symbols that can accommodate a PSFCH, the responding UE may place the multiplexed PSFCH in a configured location to enable detection by the Tx/Rx UE intended to receive the PSFCH. For example, as shown by reference number 620, the PSFCH may be located in the first PSSCH symbol after the symbol that carries the DMRS and the SCI-2, starting from the lowest PRB within a subchannel. In this way, placing the PSFCH in the first PSSCH symbol that immediately follows the symbol carrying the DMRS may improve channel estimation performance. Furthermore, the PSFCH may be located in a PSSCH symbol that follows the symbol carrying the SCI-2 such that the Tx/Rx UE can determine whether the source identifier and the destination identifier of the PSSCH respectively match the identifier of the responding UE and the Tx/Rx UE. Alternatively, as shown by reference number 625, the PSFCH may be located in the last N PRBs among the PSSCH resources allocated to the PSSCH message, where N may have a value that depends on the number of bits included in the HARQ feedback. In this way, placing the PSFCH in the last N PRBs of the PSSCH resources may simplify PSSCH rate matching.

Alternatively, as shown by reference number 630, the PSFCH may be located in the first gap symbol (e.g., after the last PSSCH symbol and prior to the legacy PSFCH symbols), starting from the lowest PRB within a subchannel. In this way, the PSFCH may be multiplexed with the PSSCH in a way that has no performance impact for the PSSCH (e.g., the PSSCH can use the full resource allocation available for the PSSCH). Furthermore, because the PSFCH occupies only a small portion of the gap symbol, which is provided to allow other sidelink UEs an opportunity to perform an LBT procedure to acquire a channel occupancy time and/or to allow switching between transmitting the PSSCH and receiving a PSFCH in the legacy PSFCH symbols, the multiplexed PSFCH may not block other sidelink UEs attempting to transmit over an unlicensed channel. However, in cases where the responding UE needs to receive a PSFCH in the legacy PSFCH resources and transmit the PSFCH in the same slot, the responding UE may be unable to switch between a transmit state and a receive state to receive the PSFCH from other UEs in the legacy PSFCH resources if the PSFCH is transmitted in the gap symbol. In this case, the responding UE may determine whether to transmit the multiplexed PSFCH in the gap symbol or receive the PSFCH in the legacy PSFCH symbols based on the priority of the associated PSSCH. For example, if the priority of the PSSCH associated with the PSFCH to be received in the legacy PSFCH symbols is higher than the PSSCH associated with the PSFCH to be transmitted in the gap symbol, the responding UE may not transmit the PSFCH in the gap symbol and may instead use the gap symbol to switch between a transmit state and a receive state to receive the PSFCH in the legacy PSFCH symbols. On the other hand, if the priority of the PSSCH associated with the PSFCH to be received in the legacy PSFCH symbols is lower than the PSSCH associated with the PSFCH to be transmitted in the gap symbol, the responding UE may transmit the PSFCH in the gap symbol and may not receive the PSFCH in the legacy PSFCH symbols.

In some aspects, the responding UE may transmit the outgoing PSSCH message using one or more layers (e.g., corresponding to one or more data streams). For example, for a MIMO transmission, the outgoing PSSCH message may be transmitted using at least two layers (at least two streams). Accordingly, in cases where two (or more) layers are used for transmission of the outgoing PSSCH message, contents associated with the PSFCH may be mapped to each of the two or more layers (e.g., the PSFCH contents are duplicated over each layer). Alternatively, in some aspects, the PSFCH may be mapped to the two or more layers, where different portions of the PSFCH may be mapped to each respective layer (e.g., when the PSFCH is associated with PUCCH format two (PF2)). Alternatively, in some aspects, the PSFCH may be mapped to only one of the two or more layers, and power boosting may be applied to the layer mapped to the PSFCH (e.g., to increase reliability of the PSFCH).

In some aspects, referring to FIG. 6C, the responding UE may need to transmit HARQ feedback that includes multiple HARQ-ACK bits for the Tx/Rx UE when a PSFCH period is greater than one slot (e.g., there may be multiple PSSCH messages transmitted between slots that include a PSFCH resource allocation). In such cases, the responding UE may need to use more than one PRB for PSFCH resources (e.g., one PRB may generally be needed to transmit one HARQ-ACK bit). Accordingly, as shown in FIG. 6C, the number of PRBs that the responding UE uses for the multiplexed PSFCH may be equal to the number of HARQ-ACK bits carried in the PSFCH. Furthermore, because the Tx/Rx UE knows how many HARQ-ACK bits need to be received from the responding UE, and the responding UE knows how many HARQ-ACK bits need to be transmitted to the Tx/Rx UE, there is no need for a PSFCH indication to indicate the number of HARQ-ACK bits carried in the multiplexed PSFCH. In addition, as shown by reference number 635, an order of the multiple HARQ-ACK bits may be aligned with a slot index order associated with the slots in which the corresponding PSSCH messages were transmitted. For example, in FIG. 6C, the responding UE may receive a first PSSCH message from the Tx/Rx UE in slot #1, a second PSSCH message from the Tx/Rx UE in slot #2, and a third PSSCH message from the Tx/Rx UE in slot #3, whereby three PRBs are used for the multiplexed PSFCH. In this case, FIG. 6C illustrates an example where the PSFCH is transmitted in the last N PRBs of the PSSCH resources, where the last PRB is used to transmit the HARQ feedback for the first PSSCH message transmitted in slot #1, the penultimate PRB is used to transmit the HARQ feedback for the second PSSCH message transmitted in slot #2, and the third-to-last PRB is used to transmit the HARQ feedback for the third PSSCH message transmitted in slot #3. It will be appreciated that the alignment of the HARQ feedback may vary if a different location is configured for the PSFCH (e.g., the HARQ feedback for the first, second, and third PSSCH messages may be mapped to the lowest, second lowest, and third lowest PRBs in the first gap symbol or the first PSSCH symbol after the symbol carrying the DMRS and SCI-2).

In some aspects, FIG. 6D illustrates a PSFCH multiplexing scenario where the responding UE receives PSSCH messages from and transmits HARQ feedback to different UEs. For example, FIG. 6D illustrates a scenario where the responding UE receives a first PSSCH message from a first Tx/Rx UE (shown as UE_{B}) in a first slot and receives a second PSSCH message from a second Tx/Rx UE (shown as UE_{C}) in a second slot. However, in cases where the outgoing PSSCH message is only transmitted to the first Tx/Rx UE, the responding UE can multiplex only the PSFCH for the first Tx/Rx UE with the outgoing PSSCH message to the first Tx/Rx UE, as shown by reference number 640. Accordingly, in cases where the responding UE also has HARQ feedback to transmit to the second Tx/Rx that is not the receiver of the outgoing PSSCH message, the PSFCH for the second Tx/Rx UE may be located in the legacy PSFCH resources rather than multiplexed with the PSSCH, as shown by reference number 645.

In some aspects, FIG. 6E illustrates a PSFCH multiplexing scenario where the responding UE receives one or more PSSCH messages from one or more UEs and multiplexes a PSFCH that includes HARQ feedback for the one or more PSSCH messages with an outgoing PSSCH that may be transmitted to a different UE. For example, FIG. 6E illustrates a scenario where the responding UE receives a first PSSCH message from a first Tx/Rx UE (shown as UE_{B}) in a first slot and receives a second PSSCH message from a second Tx/Rx UE (shown as UE_{C}) in a second slot, and the responding UE has sidelink data to transmit to a receiver UE (shown as UE_{X}) in a slot that includes a PSFCH resource allocation for the HARQ feedback associated with the PSSCH messages received in the first and second slot. In this case, the receiver UE for the outgoing PSSCH message may be the first Tx/Rx UE, the second Tx/Rx UE, or another UE (e.g., the sidelink data may or may not be transmitted to the Tx/Rx UE(s) receiving the HARQ feedback for the earlier PSSCH transmissions to the responding UE). In this case, however, the responding UE may nonetheless multiplex the PSFCH for the first and second Tx/Rx UEs with the outgoing PSSCH, as shown by reference number 650. For example, in some aspects, the responding UE may configure a field of SCI-2 in the slot carrying the PSFCH to indicate whether the PSSCH message transmitted in the slot carries HARQ feedback information. Accordingly, the Tx/Rx UEs that transmitted the earlier PSSCH messages may monitor the SCI-2 in the slot where the HARQ feedback is expected to determine whether there is HARQ feedback multiplexed with the PSSCH message. For example, if the field of the SCI-2 has a first value (e.g., one), the Tx/Rx UEs may receive the PSFCH carrying the HARQ feedback in the configured location (e.g., using one or more of the options shown in FIG. 6B and/or layer mapping rules described above). Otherwise, if the field of the SCI-2 has a second value (e.g., zero), the Tx/Rx UEs may receive the PSFCH carrying the HARQ feedback in legacy PSFCH resources. Furthermore, the Tx/Rx UEs may indicate whether the responding UE is allowed to multiplex the HARQ feedback with a PSSCH transmitted to the same or a different UE via SCI-2 (e.g., the SCI-2 can include a first field to indicate whether PSFCH multiplexing is enabled and a second field to indicate whether HARQ feedback is multiplexed with a transmitted PSSCH message). In cases where the Tx/Rx UE(s) do not detect the SCI-2 in the corresponding slot and/or the responding UE does not multiplex the PSFCH with the outgoing PSSCH message, the Tx/Rx UE(s) may attempt to receive the PSFCH in legacy PSFCH resources.

In some aspects, FIG. 6F illustrates an example where SCI-2 may include a PSFCH resource indication to indicate a number of PRBs used for a PSFCH that carries HARQ feedback for one or more Tx/Rx UEs. For example, the PSFCH resource indication may be provided by the responding UE such that one or more Tx/Rx UEs can determine the PSFCH resources carrying HARQ feedback intended for the one or more Tx/Rx UEs. For example, in some aspects, a set of candidate PSFCH resources that can be used for multiplexing a PSFCH with a PSSCH message may be configured by RRC signaling or preconfigured (e.g., in a wireless communication standard). Accordingly, as shown by reference number 655, the responding UE may configure the PSFCH resource indication in the SCI-2 to dynamically indicate one of the set of candidate PSFCH resources that carry the HARQ feedback. In this way, the responding UE can dynamically select, from the set of candidate PSFCH resources, one or more PSFCH resources to carry the HARQ feedback to adapt to different PSFCH transmission parameters (e.g., different channel conditions or different numbers of HARQ-ACK information bits). For example, FIG. 6F illustrates an example where there are three Tx/Rx UEs (shown as UE_{B}, UE_{C}, and UE_{D}) transmitting PSSCH messages to UE_{A} over three subchannels, where the PSFCH period is four (e.g., there are PSFCH resources in every fourth slot) such that there are four PSSCH slots associated with a PSFCH symbol. Accordingly, in the example illustrated in FIG. 6F, the responding UE may need a total of five (5) bits in the PSFCH to accommodate the HARQ feedback for the three Tx/Rx UEs, whereby the responding UE may set the PSFCH resource indication to dynamically select a candidate PSFCH resource that can accommodate five HARQ-ACK bits.

Furthermore, in cases where the PSFCH resource indication is used to indicate the PSFCH resources carrying the HARQ feedback, the responding UE may map the PSFCH for different UEs to the candidate PSFCH resource according to an index associated with each respective PSFCH. For example, in cases where the PSFCH is associated with PUCCH format zero (PF0), the PSFCH that is multiplexed with the PSSCH message may use the PSFCH resources indicated in the SCI-2 (e.g., NPRBs that the responding UE indicates via the PSFCH resource indication). For example, in some aspects, a number of PSFCH resources available for the HARQ feedback, F, may be based on N, which corresponds to the number of PRBs used for the HARQ feedback, and Q, which corresponds to a number of cyclic shift pairs (e.g., F=N×Q). In this example, the PSFCH with an index i may be determined as (T_{ID}+R_{ID}+Iₛₗₒₜ+I_{subchannel})mod(F), where T_{ID} is a transmitting UE identifier, R_{ID} is a receiving UE identifier, Iₛₗₒₜ is a slot index, and I_{subchannel} is a starting subchannel index. Alternatively, each HARQ-ACK bit may occupy the entire PSFCH resource allocation via repetition, and different HARQ-ACK bits may be associated with different cyclic shifts to achieve orthogonal transmission. For example, in this case, the PSFCH resource size, F, may equal the number of cyclic shift pairs, Q, and the PSFCH with an index i may be similarly determined as (T_{ID}+R_{ID}+Iₛₗₒₜ+I_{subchannel})mod(F) (e.g., the F term may have a different value when each HARQ-ACK bit occupies the entirety of the PSFCH resources). Alternatively, in cases where the PSFCH is associated with PF2, the PSFCH of each Tx/Rx UE may occupy the entire set of candidate PSFCH resources, and frequency domain orthogonal cover codes (FD-OCC) are used to separate the HARQ feedback associated with different Tx/Rx UEs. For example, the OCC index for a given Tx/Rx UE may be determined as

$$( {T}_{ID} + {R}_{ID} ) mod ( {N}_{S F}^{P S F C H} ) ,$$

where

$${N}_{S F}^{P S F C H}$$

is an OCC length.

As indicated above, FIGS. 6A-6F are provided as examples. Other examples may differ from what is described with respect to FIGS. 6A-6F.

FIG. 7 is a diagram illustrating an example process 700 performed, for example, by a UE, in accordance with the present disclosure. Example process 700 is an example where the UE (e.g., UE 120) performs operations associated with PSFCH multiplexing with a PSSCH.

As shown in FIG. 7, in some aspects, process 700 may include receiving a first PSSCH message (block 710). For example, the UE (e.g., using communication manager 140 and/or reception component 802, depicted in FIG. 8) may receive a first PSSCH message, as described above.

As further shown in FIG. 7, in some aspects, process 700 may include transmitting a second PSSCH message, wherein the second PSSCH message is multiplexed with a PSFCH that carries HARQ feedback for the first PSSCH message (block 720). For example, the UE (e.g., using communication manager 140 and/or transmission component 804, depicted in FIG. 8) may transmit a second PSSCH message, wherein the second PSSCH message is multiplexed with a PSFCH that carries HARQ feedback for the first PSSCH message, as described above.

Process 700 may include additional aspects, such as any single aspect or any combination of aspects described below and/or in connection with one or more other processes described elsewhere herein.

In a first aspect, process 700 includes multiplexing the second PSSCH message with the PSFCH that carries the HARQ feedback for the first PSSCH message based at least in part on a source identifier associated with the first PSSCH message matching a destination identifier associated with the second PSSCH message.

In a second aspect, alone or in combination with the first aspect, the PSFCH occupies an initial PSSCH message symbol of the second PSSCH message, after a symbol that carries SCI-2, and starting from a lowest PRB within a subchannel.

In a third aspect, alone or in combination with one or more of the first and second aspects, the PSFCH occupies a final one or more PRBs within PSSCH resources allocated to the second PSSCH message.

In a fourth aspect, alone or in combination with one or more of the first through third aspects, the PSFCH occupies an initial gap symbol of the second PSSCH message, starting from a lowest PRB within a subchannel.

In a fifth aspect, alone or in combination with one or more of the first through fourth aspects, the second PSSCH message is transmitted using a first layer and a second layer, and contents associated with the PSFCH are duplicated over the first layer and the second layer.

In a sixth aspect, alone or in combination with one or more of the first through fifth aspects, the second PSSCH message is transmitted using a first layer and a second layer, and the PSFCH includes a first portion mapped to the first layer and a second portion mapped to the second layer.

In a seventh aspect, alone or in combination with one or more of the first through sixth aspects, the second PSSCH message is transmitted using a first layer and a second layer, and the PSFCH is mapped to either the first layer or the second layer with power boosting applied to the layer mapped to the PSFCH.

In an eighth aspect, alone or in combination with one or more of the first through seventh aspects, the PSFCH occupies a number of PRBs equal to a number of bits included in the HARQ feedback.

In a ninth aspect, alone or in combination with one or more of the first through eighth aspects, the HARQ feedback includes multiple bits carried in resources associated with the PSFCH that are aligned with a slot index order in which the first PSSCH message was transmitted.

In a tenth aspect, alone or in combination with one or more of the first through ninth aspects, process 700 includes receiving a third PSSCH message prior to transmitting the second PSSCH message, and transmitting HARQ feedback for the third PSSCH message in a PSFCH resource selected from a PSFCH resource pool based at least in part on a source identifier associated with the third PSSCH message differing from the source identifier associated with the first PSSCH message.

In an eleventh aspect, alone or in combination with one or more of the first through tenth aspects, process 700 includes receiving a third PSSCH message prior to transmitting the second PSSCH message, wherein a source identifier associated with the third PSSCH message is different from the source identifier associated with the first PSSCH message, and multiplexing HARQ feedback for the third PSSCH message with the second PSSCH message and the PSFCH that carries the HARQ feedback for the first PSSCH message.

In a twelfth aspect, alone or in combination with one or more of the first through eleventh aspects, the first PSSCH message and the third PSSCH message each include SCI-2 indicating that the HARQ feedback can be multiplexed with the second PSSCH message.

In a thirteenth aspect, alone or in combination with one or more of the first through twelfth aspects, the second PSSCH message includes SCI-2 indicating that the second PSSCH message carries the HARQ feedback for the first PSSCH message and the HARQ feedback for the third PSSCH message.

In a fourteenth aspect, alone or in combination with one or more of the first through thirteenth aspects, the SCI-2 includes a PSFCH resource indication to indicate a number of PRBs for the HARQ feedback.

In a fifteenth aspect, alone or in combination with one or more of the first through fourteenth aspects, the PSFCH resource indication included in the SCI-2 indicates a PSFCH resource value within a set of candidate PSFCH resources.

In a sixteenth aspect, alone or in combination with one or more of the first through fifteenth aspects, PSFCH resources associated with the HARQ feedback for the first PSSCH message and the second PSSCH message are associated with PF0.

In a seventeenth aspect, alone or in combination with one or more of the first through sixteenth aspects, the PSFCH resources associated with the HARQ feedback use one or more PRBs indicated in SCI-2.

In an eighteenth aspect, alone or in combination with one or more of the first through seventeenth aspects, each bit of the HARQ feedback occupies all of the PSFCH resources using repetitions and different cyclic shifts for different bits of the HARQ feedback.

In a nineteenth aspect, alone or in combination with one or more of the first through eighteenth aspects, an index of the PSFCH resources associated with the HARQ feedback is based at least in part on one or more of a source UE identifier, a receiving UE identifier, a slot index, or a starting subchannel index.

In a twentieth aspect, alone or in combination with one or more of the first through nineteenth aspects, PSFCH resources associated with the HARQ feedback for the first PSSCH message and the second PSSCH message are associated with PF2.

In a twenty-first aspect, alone or in combination with one or more of the first through twentieth aspects, HARQ feedback associated with different UEs that have different source identifiers each occupies all of the PSFCH resources using FD-OCC to separate the HARQ feedback associated with the different UEs.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include the communication manager 140. The communication manager 140 may include a PSFCH multiplexing component 808, among other examples.

In some aspects, the apparatus 800 may be configured to perform one or more operations described herein in connection with FIGS. 6A-6F. Additionally, or alternatively, the apparatus 800 may be configured to perform one or more processes described herein, such as process 700 of FIG. 7. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The reception component 802 may receive a first PSSCH message. The transmission component 804 may transmit a second PSSCH message, wherein the second PSSCH message is multiplexed with a PSFCH that carries HARQ feedback for the first PSSCH message.

The PSFCH multiplexing component 808 may multiplex the second PSSCH message with the PSFCH that carries the HARQ feedback for the first PSSCH message based at least in part on a source identifier associated with the first PSSCH message matching a destination identifier associated with the second PSSCH message.

The reception component 802 may receive a third PSSCH message prior to transmitting the second PSSCH message. The transmission component 804 may transmit HARQ feedback for the third PSSCH message in a PSFCH resource selected from a PSFCH resource pool based at least in part on a source identifier associated with the third PSSCH message differing from the source identifier associated with the first PSSCH message.

The reception component 802 may receive a third PSSCH message prior to transmitting the second PSSCH message, wherein a source identifier associated with the third PSSCH message is different from the source identifier associated with the first PSSCH message. The PSFCH multiplexing component 808 may multiplex HARQ feedback for the third PSSCH message with the second PSSCH message and the PSFCH that carries the HARQ feedback for the first PSSCH message.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a UE, comprising: receiving a first PSSCH message; and transmitting a second PSSCH message, wherein the second PSSCH message is multiplexed with a PSFCH that carries HARQ feedback for the first PSSCH message.

Aspect 2: The method of Aspect 1, further comprising: multiplexing the second PSSCH message with the PSFCH that carries the HARQ feedback for the first PSSCH message based at least in part on a source identifier associated with the first PSSCH message matching a destination identifier associated with the second PSSCH message.

Aspect 3: The method of Aspect 2, wherein the PSFCH occupies an initial PSSCH message symbol of the second PSSCH message, after a symbol that carries SCI-2, and starting from a lowest PRB within a subchannel.

Aspect 4: The method of Aspect 2, wherein the PSFCH occupies a final one or more PRBs within PSSCH resources allocated to the second PSSCH message.

Aspect 5: The method of Aspect 2, wherein the PSFCH occupies an initial gap symbol of the second PSSCH message, starting from a lowest PRB within a subchannel.

Aspect 6: The method of any of Aspects 2-5, wherein the second PSSCH message is transmitted using a first layer and a second layer, and wherein contents associated with the PSFCH are duplicated over the first layer and the second layer.

Aspect 7: The method of any of Aspects 2-5, wherein the second PSSCH message is transmitted using a first layer and a second layer, and wherein the PSFCH includes a first portion mapped to the first layer and a second portion mapped to the second layer.

Aspect 8: The method of any of Aspects 2-5, wherein the second PSSCH message is transmitted using a first layer and a second layer, and wherein the PSFCH is mapped to either the first layer or the second layer with power boosting applied to the layer mapped to the PSFCH.

Aspect 9: The method of any of Aspects 2-8, wherein the PSFCH occupies a number of PRBs equal to a number of bits included in the HARQ feedback.

Aspect 10: The method of any of Aspects 2-9, wherein the HARQ feedback includes multiple bits carried in resources associated with the PSFCH that are aligned with a slot index order in which the first PSSCH message was transmitted.

Aspect 11: The method of any of Aspects 2-10, further comprising: receiving a third PSSCH message prior to transmitting the second PSSCH message; and transmitting HARQ feedback for the third PSSCH message in a PSFCH resource selected from a PSFCH resource pool based at least in part on a source identifier associated with the third PSSCH message differing from the source identifier associated with the first PSSCH message.

Aspect 12: The method of any of Aspects 2-10, further comprising: receiving a third PSSCH message prior to transmitting the second PSSCH message, wherein a source identifier associated with the third PSSCH message is different from the source identifier associated with the first PSSCH message; and multiplexing HARQ feedback for the third PSSCH message with the second PSSCH message and the PSFCH that carries the HARQ feedback for the first PSSCH message.

Aspect 13: The method of Aspect 12, wherein the first PSSCH message and the third PSSCH message each include SCI-2 indicating that the HARQ feedback can be multiplexed with the second PSSCH message.

Aspect 14: The method of any of Aspects 12-13, wherein the second PSSCH message includes SCI-2 indicating that the second PSSCH message carries the HARQ feedback for the first PSSCH message and the HARQ feedback for the third PSSCH message.

Aspect 15: The method of Aspect 14, wherein the SCI-2 includes a PSFCH resource indication to indicate a number of PRBs for the HARQ feedback.

Aspect 16: The method of Aspect 15, wherein the PSFCH resource indication included in the SCI-2 indicates a PSFCH resource value within a set of candidate PSFCH resources.

Aspect 17: The method of any of Aspects 12-16, wherein PSFCH resources associated with the HARQ feedback for the first PSSCH message and the second PSSCH message are associated with PF0.

Aspect 18: The method of Aspect 17, wherein the PSFCH resources associated with the HARQ feedback use one or more PRBs indicated in SCI-2.

Aspect 19: The method of any of Aspects 17-18, wherein each bit of the HARQ feedback occupies all of the PSFCH resources using repetitions and different cyclic shifts for different bits of the HARQ feedback.

Aspect 20: The method of any of Aspects 17-19, wherein an index of the PSFCH resources associated with the HARQ feedback is based at least in part on one or more of a source UE identifier, a receiving UE identifier, a slot index, or a starting subchannel index.

Aspect 21: The method of any of Aspects 12-16, wherein PSFCH resources associated with the HARQ feedback for the first PSSCH message and the second PSSCH message are associated with PF2.

Aspect 22: The method of Aspect 21, wherein HARQ feedback associated with different UEs that have different source identifiers each occupies all of the PSFCH resources using frequency domain orthogonal cover codes to separate the HARQ feedback associated with the different UEs.

Aspect 23: An apparatus for wireless communication at a device, comprising a processor; memory coupled with the processor; and instructions stored in the memory and executable by the processor to cause the apparatus to perform the method of one or more of Aspects 1-22.

Aspect 24: A device for wireless communication, comprising a memory and one or more processors coupled to the memory, the one or more processors configured to perform the method of one or more of Aspects 1-22.

Aspect 25: An apparatus for wireless communication, comprising at least one means for performing the method of one or more of Aspects 1-22.

Aspect 26: A non-transitory computer-readable medium storing code for wireless communication, the code comprising instructions executable by a processor to perform the method of one or more of Aspects 1-22.

Aspect 27: A non-transitory computer-readable medium storing a set of instructions for wireless communication, the set of instructions comprising one or more instructions that, when executed by one or more processors of a device, cause the device to perform the method of one or more of Aspects 1-22.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
receiving a first physical sidelink shared channel (PSSCH) message; and
transmitting a second PSSCH message, wherein the second PSSCH message is multiplexed with a physical sidelink feedback channel (PSFCH) that carries hybrid automatic repeat request (HARQ) feedback for the first PSSCH message.

2. The method of claim 1, further comprising:
multiplexing the second PSSCH message with the PSFCH that carries the HARQ feedback for the first PSSCH message based at least in part on a source identifier associated with the first PSSCH message matching a destination identifier associated with the second PSSCH message.

3. The method of claim 2, wherein the PSFCH occupies an initial PSSCH message symbol of the second PSSCH message, after a symbol that carries second stage sidelink control information, and starting from a lowest physical resource block within a subchannel.

4. The method of claim 2, wherein the PSFCH occupies a final one or more physical resource blocks within PSSCH resources allocated to the second PSSCH message.

5. The method of claim 2, wherein the PSFCH occupies an initial gap symbol of the second PSSCH message, starting from a lowest physical resource block within a subchannel.

6. The method of claim 2, wherein the second PSSCH message is transmitted using a first layer and a second layer, and wherein contents associated with the PSFCH are duplicated over the first layer and the second layer.

7. The method of claim 2, wherein the second PSSCH message is transmitted using a first layer and a second layer, and wherein the PSFCH includes a first portion mapped to the first layer and a second portion mapped to the second layer.

8. The method of claim 2, wherein the second PSSCH message is transmitted using a first layer and a second layer, and wherein the PSFCH is mapped to either the first layer or the second layer with power boosting applied to the layer mapped to the PSFCH.

9. The method of claim 2, wherein the PSFCH occupies a number of physical resource blocks equal to a number of bits included in the HARQ feedback.

10. The method of claim 2, wherein the HARQ feedback includes multiple bits carried in resources associated with the PSFCH that are aligned with a slot index order in which the first PSSCH message was transmitted.

11. The method of claim 2, further comprising:
receiving a third PSSCH message prior to transmitting the second PSSCH message; and
transmitting HARQ feedback for the third PSSCH message in a PSFCH resource selected from a PSFCH resource pool based at least in part on a source identifier associated with the third PSSCH message differing from the source identifier associated with the first PSSCH message.

12. The method of claim 2, further comprising:
receiving a third PSSCH message prior to transmitting the second PSSCH message, wherein a source identifier associated with the third PSSCH message is different from the source identifier associated with the first PSSCH message; and
multiplexing HARQ feedback for the third PSSCH message with the second PSSCH message and the PSFCH that carries the HARQ feedback for the first PSSCH message.

13. The method of claim 12, wherein the first PSSCH message and the third PSSCH message each include second stage sidelink control information indicating that the HARQ feedback can be multiplexed with the second PSSCH message.

14. The method of claim 12, wherein the second PSSCH message includes second stage sidelink control information (SCI-2) indicating that the second PSSCH message carries the HARQ feedback for the first PSSCH message and the HARQ feedback for the third PSSCH message.

15. The method of claim 14, wherein the SCI-2 includes a PSFCH resource indication to indicate a number of physical resource blocks for the HARQ feedback.

16. The method of claim 15, wherein the PSFCH resource indication included in the SCI-2 indicates a PSFCH resource value within a set of candidate PSFCH resources.

17. The method of claim 12, wherein PSFCH resources associated with the HARQ feedback for the first PSSCH message and the second PSSCH message are associated with PSFCH format zero (PF0).

18. The method of claim 17, wherein the PSFCH resources associated with the HARQ feedback use one or more physical resource blocks indicated in second stage sidelink control information.

19. The method of claim 17, wherein each bit of the HARQ feedback occupies all of the PSFCH resources using repetitions and different cyclic shifts for different bits of the HARQ feedback.

20. The method of claim 17, wherein an index of the PSFCH resources associated with the HARQ feedback is based at least in part on one or more of a source UE identifier, a receiving UE identifier, a slot index, or a starting subchannel index.

21. The method of claim 12, wherein PSFCH resources associated with the HARQ feedback for the first PSSCH message and the second PSSCH message are associated with physical uplink control channel format two (PF2).

22. The method of claim 21, wherein HARQ feedback associated with different UEs that have different source identifiers each occupies all of the PSFCH resources using frequency domain orthogonal cover codes to separate the HARQ feedback associated with the different UEs.

23. A user equipment (UE) for wireless communication, comprising:
a memory; and
one or more processors, coupled to the memory, configured to:
receive a first physical sidelink shared channel (PSSCH) message; and
transmit a second PSSCH message, wherein the second PSSCH message is multiplexed with a physical sidelink feedback channel (PSFCH) that carries hybrid automatic repeat request (HARQ) feedback for the first PSSCH message.

24. The UE of claim 23, wherein the one or more processors are further configured to:
multiplex the second PSSCH message with the PSFCH that carries the HARQ feedback for the first PSSCH message based at least in part on a source identifier associated with the first PSSCH message matching a destination identifier associated with the second PSSCH message.

25. The UE of claim 24, wherein the PSFCH occupies:
an initial PSSCH message symbol of the second PSSCH message, after a symbol that carries second stage sidelink control information, and starting from a lowest physical resource block within a subchannel,
a final one or more physical resource blocks within PSSCH resources allocated to the second PSSCH message, or
an initial gap symbol of the second PSSCH message, starting from a lowest physical resource block within a subchannel.

26. The UE of claim 24, wherein the second PSSCH message is transmitted using a first layer and a second layer, and wherein the PSFCH is mapped to one or more of the first layer or the second layer.

27. The UE of claim 24, wherein the PSFCH occupies a number of physical resource blocks equal to a number of bits included in the HARQ feedback.

28. The UE of claim 24, wherein the HARQ feedback includes multiple bits carried in resources associated with the PSFCH that are aligned with a slot index order in which the first PSSCH message was transmitted.

29. A non-transitory computer-readable medium storing a set of instructions for wireless communication, the set of instructions comprising:
one or more instructions that, when executed by one or more processors of a user equipment (UE), cause the UE to:
receive a first physical sidelink shared channel (PSSCH) message; and
transmit a second PSSCH message, wherein the second PSSCH message is multiplexed with a physical sidelink feedback channel (PSFCH) that carries hybrid automatic repeat request (HARQ) feedback for the first PSSCH message.

30. An apparatus for wireless communication, comprising:
means for receiving a first physical sidelink shared channel (PSSCH) message; and
means for transmitting a second PSSCH message, wherein the second PSSCH message is multiplexed with a physical sidelink feedback channel (PSFCH) that carries hybrid automatic repeat request (HARQ) feedback for the first PSSCH message.
